(19) United States
(12) Patent Application Publication
(10) Pub. No.: US 2014/0100065 A1
(43) Pub. Date: Apr. 10, 2014

(54) ROLLED BASEBALL BAT

(71) Applicant: Brian HARTSOCK, Corona, CA (US)

(72) Inventor: Brian HARTSOCK, Corona, CA (US)

(21) Appl. No.: 13/914,328

(22) Filed: Jun. 10, 2013

Related U.S. Application Data
(60) Provisional application No. 61/712,163, filed on Oct. 10, 2012.

(51) Int. Cl. A63B 59/06; B27M 3/00; B27M 3/22

(52) U.S. Cl. CPC A63B 59/06; B27M 3/22; B27M 3/0086
USPC 473/564; 144/344

(57) ABSTRACT

An improved laminated bat is presented using a wood inner core that maintains a constant “feel” to the bat when a ball is struck. The use of a wood inner core further ensure consent thermal expansion and bending as the bat is used to impact a ball. Progressively narrower veneer sheets of wood are heated to bond thermoset glue on the inner core to approximate the finished contour of the bat. Veneer layers are also pressed onto the bat thereby providing a completely bonded bat with any air bubbles removed when the last layer of veneer is rolled onto the bat. This reduces the amount of post processing of the bat and results in a nearly finished shape when the veneer is applied. The overlapping wood grain increases the strength of the bat and eliminated inconsistencies with hitting a ball at a particular side of the bat.

### CROSS REFERENCE TO RELATED APPLICATIONS

This application claims the benefit of Provisional Application Ser. No. 61/712,163 filed Oct. 10, 2012 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the invention

This invention relates to improvements in construction of a baseball bat. More particularly, the present bat is constructed with a base dowel where layers of veneer are bonded and pressed onto the dowel to form a finished bat.

2. Description of Related Art including information disclosed under 37 CFR 1.97 and 1.98.

The sports of baseball or softball are familiar games where a pitcher throws a ball at a hitter that tries to strike the ball with a bat. There are variations on the game that involve a person trying to hit a ball or similar object with a bat or club. The material and construction of the bat is critical to the comfort of the hitter as well as the resulting travel of the ball once it is struck with the bat. Original bats were simply sticks or trimmed limbs from a tree. Later versions of bats were turned from blanks of hardwood dowels of Ash, Birch and Maple. Maple wood bats generally have more pop than ash bats, but are more likely to break on miss-hits off the end of the barrel. Ash wood bats tend to have larger sweet spots than maple bats, but are more likely to break on miss-hits off the handle. Most bats are fabricated in lengths of between 31″-35″.

Bats usually break with the grain of the bat and the label is often printed on the bat to indicate the best side to strike at a ball. While the optimal area to strike a ball can be marked onto a bat a player often swings at a ball in any orientation of the bat. To combat bat orientation issues, bat can be constructed with the grain placed in different orientations. A number of patents and or publications have been made to address these issues.

Exemplary examples of patents and or publication that try to address this/these problem(s) are identified and discussed below.

U.S. Pat. No. 1,063,563 issued on Jun. 3, 1913 to L. S. May discloses a bat with an inner core of gain oriented in a first direction and an outer shell with the grain oriented in a second direction. While this disclosure provides a bat with varying grain direction, the optimal strike direction can be doubled, but the complexity to construct this type of bat has significantly increased.

U.S. Pat. No. 2,379,006 issued on Aug. 30, 1943 to T. L. Johnson discloses a construction of striking Implements. The construction of this striking implement begins with a tapered inner metal core. Thin strips of veneer are progressively laid over the inner metal core until the desired size and shape of the bat is complete. The bat is then placed under pressure in an oven to cure. Weights are then added to the inside metal core to balance the bat. While this bat is made with layers of veneer, the veneer is placed over a tapered metal core and the curing of the bonding agent is applied after the veneer is completely laid. Setting the glue after all of the veneer has been applied results in air pockets and uneven bonding because the glue is escaping through the veneer layers.

U.S. Pat. No. 4,572,508 issued on Feb. 25, 1986 to Chin-San You discloses a Composite Laminated Baseball bat. The bat is constructed with multiple layers of wood planks that are bonded together after. After the multiple layers of wood have been bonded the laminated blank is machined (turned) into a bat using conventional bat fabrication techniques. While this results in a stronger bat, the bonding direction of the planks of wood remains the same.

U.S. Pat. Nos. 5,114,144, 5,458,330, 5,624,115 and 6,152,840 all issued to Charles S. Baum disclose a Composite Baseball Bat with Cavitied Core. The bat is constructed over an inner hollow or solid core of foam. Two halves of veneer are bonded to the outer sides of the foam core and then secured under pressure. Progressive halves are added to the bat until the desired size and shape is achieved. The construction of the bat requires that the bat be bonded and cured several times in the process and further the inner core is a soft material that can allow the core to collapse upon impact.

What is needed is a laminate bat where the layers are rolled onto a wooden inner core and the laminated layers are heated and bonded as they are applied to the wooden inner core. The proposed rolled baseball bat provides this solution where the inner core starts as a wooden dowel and veneer is heated, stretched, pressed and bonded onto the inner dowel.

### BRIEF SUMMARY OF THE INVENTION

It is an object of the rolled baseball bat to utilize a wood inner core. The use of a wood inner core maintains a constant “feel” to the bat when a ball is struck. The use of a wood inner core further ensure consent thermal expansion and bending as the bat is used to impact an object such as a ball. The wood inner core is a constant diameter dowel and the contour of the bat is added to the initial dowel rod.

It is an object of the rolled baseball bat to be constructed with progressive narrower veneer sheets of material. The each sheet is rolled onto the dowel, or the previous sheet, in progressively narrowing manner to approximate the finished contour of the bat. This reduces the amount of post processing of the bat and results in a nearly finished shape when the veneer is applied. A single progressively narrowing sheet can also be used. Because the initial dowel starts as a constant diameter the sheets of veneer do not “walk” in either direction on the dowel. Even the knob of the bat is rolled onto the dowel in layers that approximate the finished knob.

It is another object of the rolled baseball bat for the veneer to roll onto the dowel with the grain of the veneer layer so the grain overlaps. The overlapping wood grain increases the strength of the bat and eliminated inconsistencies with hitting a ball at a particular side of the bat. While complete cross grain may vary based upon successive layers, the aggregate result will provide a nearly constant striking and bending response to the bat.

It is still another object of the rolled baseball bat to be constructed by heating the veneer and or the base dowel as the veneer is laid onto the dowel. In addition to the heating that sets the thermoset glue, each layer of veneer is pressed onto the dowel or the previous layers thereby providing a completely bonded bat with any air bubbles removed when the last layer of veneer is rolled onto the bat. Other types of liquid, pressure or contact glues can also be used.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of an initial dowel on a lathe with the elongated heating element.

FIG. 2 shows a perspective view of the temperature control box for the heating element.

FIG. 3 shows a perspective view of a veneer sheet being prepped with a thermoset sheet.

FIG. 4 shows a perspective view of a veneer sheet being added to the evolving bat.

FIG. 5 shows a plan view of a bat after the veneer has been applied.

FIG. 6 shows an end view of the bat.

FIG. 7 shows a plan view of the finished bat.

FIG. 8 shows a single final wrap of veneer.

### DETAILED DESCRIPTION OF THE INVENTION

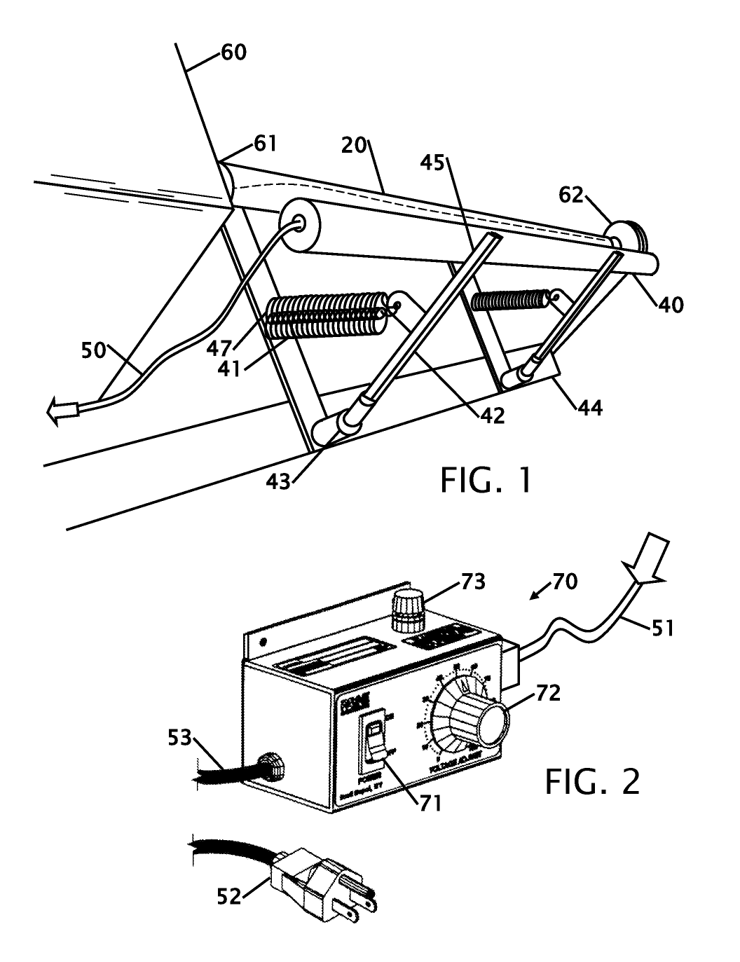

FIG. 1 shows a perspective view of an initial dowel on a lathe with the elongated heating element 40. The baseball bat begins with an elongated solid wooden dowel rod 20. The wooden dowel rod 20 is securing into a rotating device. The inner dowel rod has diameter of between ¾ inch and 1½ inch and approximates the final diameter of the minimal inside diameter of the finished bat. Different types of dowel rod woods can be used to obtain different levels of weight flexibility to the bat. These woods include but are not limited to Ash, Birch or Maple. In the preferred embodiment the rotating device is a lath or similar device that secures both the ends 61 and 62 of the wooden dowel rod 20 and allows the rod 20 to turn on the central axis of the rod 20. An elongated heating element 40 is used to heat the rod 20, thermoset glue and sheets of veneer that are bonded to the rod 20.

The elongated heating element 40 also maintains a constant pressure on the rod 40 using one or a plurality of springs 41, 47 that are attached onto pivoting arms 42 pull the elongated heating element 40 into the rod 20. The variable amount of springs 41, 47 allows the pressure to be adjustable throughout the roll and prevents walking of the veneer. In another contemplated embodiment the connection of the spring 41 or 47 can be connected to a turnbuckle that is adjusted to change the extended length of the spring 41, 47 to change the force on the veneer. The pressure from the springs 41 ensure complete bonding of the veneer layers and rolls out any air bubbles between successive veneer layers. While springs are shown and disclosed in this preferred embodiment, other pressure application mechanisms are contemplated including but not limited to hydraulic or pneumatic cylinders. While Veneer layers are available in different thickness, but typically are available in thickness of 0.010 to 0.031 inches in thickness. The arms 42 pivot on hinges 43 that are secured to the base 44 that is secured to the lath 60 or similar turning mechanism. The end(s) 45 of the arm(s) 42 are secured to the heating element 40. In the preferred embodiment the elongated heating element is contained with thin a thermal mass structure that ensures a more constant temperature. The temperature of the elongated heating element 40 is controlled by a temperature control box that the elongated heating element 40 is plugged into or otherwise connected with wiring 50.

FIG. 2 shows a perspective view of the temperature control box 70 for the heating element. The elongated heating element from FIG. 1 is wired 51, plugged or otherwise connected into the temperature control box 70. The temperature control box 70 is connected with a cord 53 and a plug 52 to an electrical outlet. The temperature control box 70 has a power switch 71 that turns the temperature control box 70 on and off. A thermostat 72, or similar control knob, sets and or adjusts the amount of heat or temperature of the elongated heating element 60. The temperature must be controlled to ensure proper heating of thermoset glue, without burning the veneer of increasing the production time to produce a single bat. A fuse 73 provides protection from an overload condition. A thermocouple may also be used to allow the temperature control box 70 to automatically maintain a desired temperature for the elongated heating element.

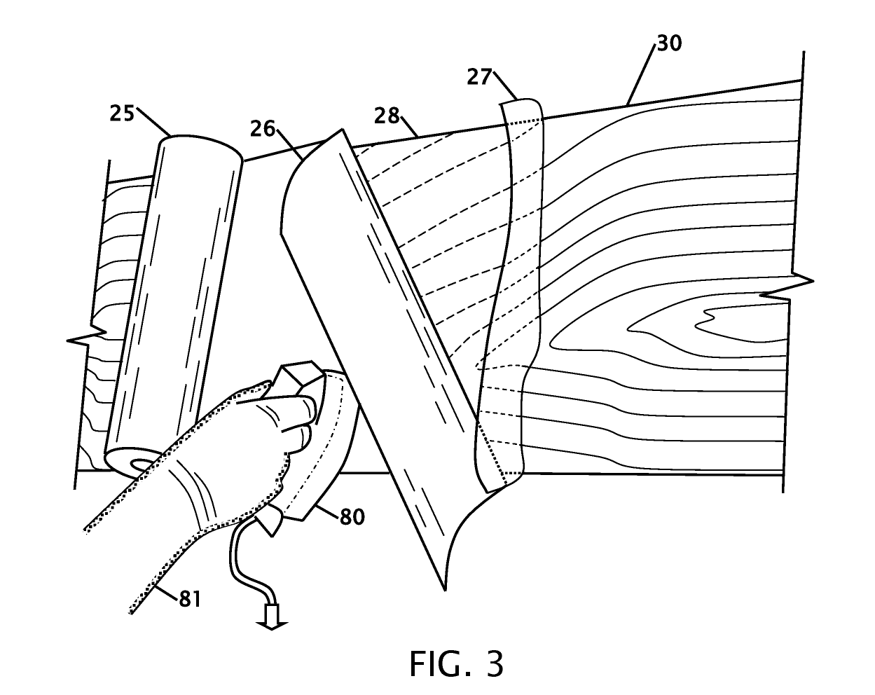

FIG. 3 shows a perspective view of a veneer sheet being prepped with a thermoset sheet. Between the dowel rod and the veneer sheets a bonding agent is used. In the preferred embodiment the bonding agent is thermoset glue, but other cold or hide glues can be used including but not limited to pressure or contact glues or sheets. The use of thermoset glues ensure quicker production processing because the bat cools rather than requiring a drying time. Two part epoxy type glues are also contemplated, but the application of liquid glues often include requiring constant application thickness of the glue and can further result in dripping glue. The thermoset glue used in the preferred embodiment comes from a roll 25 of thermoset glue that is delivered on a roll 25 with a paper separation layer 26.

Thermoset glues are typically available in thicknesses of 0.1 mm to 2.0 mm. In the preferred embodiment, thermoset glues of 0.1 mm are used, but other thicknesses can be used depending upon the type and thickness of the veneer and the underlying dowel. The thermoset glue 27 is laid onto the veneer 30. Heat is applied with an iron 80 or other heat setting mechanism with a user 81 applying the heat and even pressure to provide an initial bond with one side of the veneer 30 to provide a veneer 30 with a bonded thermoset material 28. Once prepped the veneer sheet can be bonded to the dowel rod or previous layers of veneer.

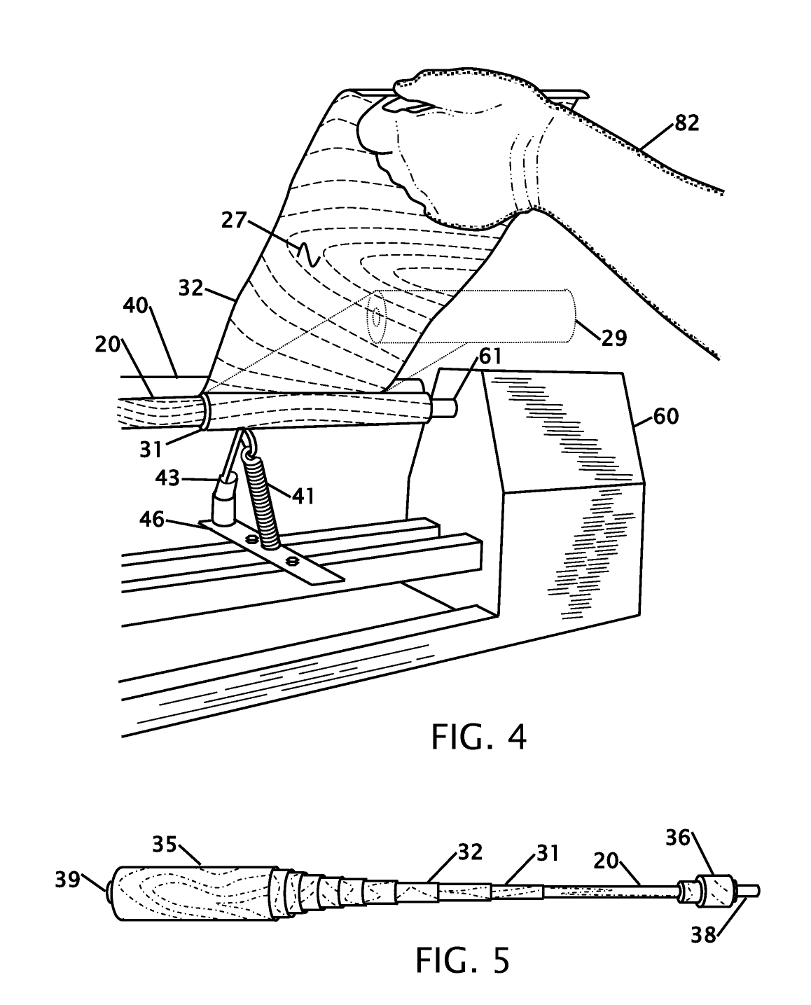

FIG. 4 shows a perspective view of a veneer sheet being added to the evolving bat. In the preferred embodiment the veneer sheets 32 are prepared as increasingly narrower strips to minimize shaping after all of the layers have been applied. It is also contemplated that a single veneers sheet can be used where the single sheet is formed in a taper from the initial layer to the final layer that will be applied. In another contemplated embodiment, veneers of different wood types can be applied to alter the response of the bat and or to alter the cosmetic appearance of the finished bat.

This figure shows the lath 60 with one end 61 of the dowel rod 20 secured into the lath 60. A user 82 is shows feeding a sheet of veneer 32 onto the previous veneer layer 31. The inner side 27 of the veneer 32 has the thermoset material pre-applied as shown in FIG. 3. It is also contemplated that the thermoset material can be applied 29 from the roll between the veneer sheet and the dowel rod 20. This figure shows the heating element 40 on the other side of the dowel 20. The elongated heating element 40 maintains a constant pressure on the rod 40 using one or a plurality of springs 41 that are attached onto pivoting arms 42 pull the elongated heating element 40 into the rod 20. The pressure from the springs 41 ensure complete bonding of the veneer layers and rolls out any air bubbles between successive veneer layers. The arms 42 pivot on hinges 43 that are secured to the base 46 that is secured to the lath 60 or similar turning mechanism. The figure shows the veneer being applied to the striking portion of the bat, and a similar application of veneer is applied to the knob portion of the bat.

FIG. 5 shows a plan view of a bat after the veneer has been applied. The base wooden dowel rod 20 is shown with the original diameter. The wooden dowel rod ends extend out both sides 38 and 39 of the bat. These ends 38 and 39 where used to grasp the bat to support turning the veneer over the wooden dowel rod 20. The progressive layers 31 and 32 of veneer are shown as the bat increases in diameter to achieve the final diameter 35 of the bat. The wood grain can be cross stitched wood grain bands of veneer. The cross stitched grain bands are applied to the entire length of the bat to create higher tensile and sheer strength and a greater “trampoline effect” or the exit speed of the ball from the bat. On the opposing side, layers of veneer are applied to achieve the desired diameter of the knob 36 of the bat.

FIG. 6 shows an end view of the bat. This end view shows the original wooden dowel rod 20 from the grip portion of the bat and the end material 39 that is gripped in the lath. Successive layers of veneer are shown to achieve the desired finished diameter 35.

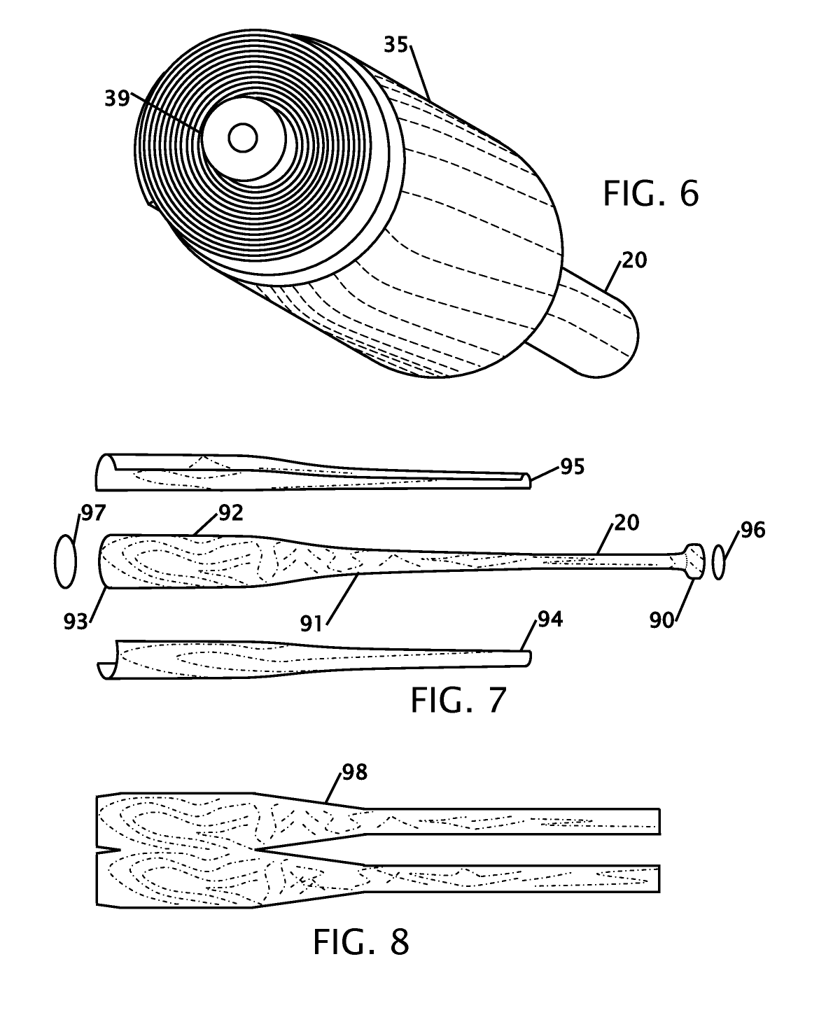

FIG. 7 shows a plan view of the finished bat. Ends 38 and 39 of the bat, from FIG. 5, have been removed and the exterior of the bat have been machined or sanded smooth to provide a finished surface where the bat gradually tapers 91 from the grip portion to the batting area 92. The end 93 is rounded along with the knob 90 of the bat.

After the layers have been bonded onto the baseball bat the barrel and cap are honed to approximately ⅛ inch to ensure that the bat is concentric. A final wrap of two ½ wraps 94, 95 are scored and bonded to the opposing sides of the honed baseball bat.

Separate end caps are secured to the ends 96 and 97 of the trimmed bat to reduce moisture from entering any end grain and provide a more finished appearance. The bat can then be varnished or sealed to create a finished product. FIG. 8 shows a single final wrap of veneer that can be applied to the honed bat.

Thus, specific embodiments of a rolled baseball bat have been disclosed. It should be apparent, however, to those skilled in the art that many more modifications besides those described are possible without departing from the inventive concepts herein. The inventive subject matter, therefore, is not to be restricted except in the spirit of the appended claims.

1. A rolled baseball bat comprising:
an inner wooden dowel;
a plurality of veneer sheets;
an elongated heating element;
at least one layer of bonding material,
a method making a baseball bat wherein said at least one layer of bonding material is applied to one side of said plurality of veneer sheets,
rolling said veneer and said at least one layer of bonding material onto said inner wooden dowel while applying heat and pressure from said elongated heating element to bond said plurality of veneer sheets to said inner wooden dowel and any previously bonded veneer sheets while expelling air and bubbles from said plurality of veneer sheets.

2. The rolled baseball bat according to claim 1 wherein said plurality of veneers sheets are applied in progressively narrowing sheets to approximate a taper to a finished baseball bat.

3. The rolled baseball bat according to claim 1 wherein said at least one layer of bonding material is a thickness of between 0.1 and 0.5 mm.

4. The rolled baseball bat according to claim 1 wherein said plurality of veneer sheets have a thickness of between 0.010 to 0.031 inches.

5. The rolled baseball bat according to claim 1 wherein said inner dowel rod has a diameter of between ¾ inch and 1½ inch.

6. The rolled baseball bat according to claim 1 wherein the initial diameter of the inner dowel rod is essentially the same diameter of the final diameter of the minimal diameter of the baseball bat.

7. The rolled baseball bat according to claim 1 that uses thermal set glue between layers of veneer.

8. The rolled baseball bat according to claim 1 that further includes honing the rolled baseball bat.

9. The rolled baseball bat according to claim 8 that further includes a final wrap of veneer that are scored and bonded to said rolled baseball bat.

10. The rolled baseball bat according to claim 9 wherein separate end caps are applied to each end of the baseball bat.

11. The rolled baseball bat according to claim 1 wherein said baseball bat has an essentially finished length of between 31 and 35 inches.

12. The rolled baseball bat according to claim 1 wherein said pressure is created by at least two springs.

13. The rolled baseball bat according to claim 1 wherein a temperature of said heating element is controlled by a temperature controller.

14. The rolled baseball bat according to claim 1 wherein said bonding material is activated by heat.

15. The rolled baseball bat according to claim 1 wherein said bonding material is initially bonded to one side of said veneer.

16. The rolled baseball bat according to claim 1 wherein said bonding material is rolled onto said wooden dowel or baseball bat between said sheets of veneer.

17. The rolled baseball bat according to claim 1 wherein said layers of veneer are bonded with grain in different directions.

18. The rolled baseball bat according to claim 1 wherein said layers of veneer are different types of wood.

19. The rolled baseball bat according to claim 1 wherein said bonding agent is a thermoset glue.

20. The rolled baseball bat according to claim 1 wherein said veneer is selected from a group comprising Ash, Birch and Maple.
